(19) United States
(12) Patent Application Publication
(10) Pub. No.: US 2009/0271274 A1
(43) Pub. Date: Oct. 29, 2009

(54) SYSTEMS AND METHODS FOR LISTING, BUYING AND SELLING PATENTS AND PATENT APPLICATIONS ONLINE

(76) Inventor: Jeremiah James Baunach, Beijing (CN)

Correspondence Address: Jeremiah J. Baunach, 1700 Seventh Ave., Suite 2100, Seattle, WA, 98101, US

(21) Appl. No.: 12/429,211

(22) Filed: Apr. 24, 2009

Related U.S. Application Data
(60) Provisional application No. 61/125,362, filed on Apr. 25, 2008.

(51) Int. Cl. G06Q 30/00; G06N 5/02

(52) U.S. Cl. 705/14.73; 706/50

(57) ABSTRACT

A system for listing patent or patent application intellectual property assets for sale or license may comprise means for receiving an intellectual property asset document number through an online interface, means for automatically extracting textual data regarding an intellectual property asset using the number received as input to a remote online system that serves over a network the textual data regarding the intellectual property asset, means for automatically storing the extracted data in a listing of the intellectual property asset, means for automatically advertising the intellectual property asset for sale or license using the stored data and means for automatically providing the listing in a searchable database of listings advertising intellectual property assets for sale or license such that the textual data regarding the intellectual property asset is searchable to users of the database, wherein the intellectual property asset is a patent or patent application.

### CROSS REFERENCE TO RELATED APPLICATIONS

Priority is hereby claimed under 35 U.S.C. 119(e) to provisional U.S. Patent Application 61/125,362 entitled “Systems and Methods for a Patent Market” filed Apr. 25, 2008, the entirety of which is hereby incorporated by reference.

### BACKGROUND

A patent is a set of rights granted by a government to a person for a fixed period of time in exchange for the public disclosure of the invention. These rights typically include the right to exclude others from using the invention claimed in the patent. A person obtains a patent by applying for one at the appropriate governmental office. In the United States, this office is the U.S. Patent and Trademark Office. The patent application includes a technical description of the invention and a set of “claims” at the end of the patent application that legally defines the scope of the invention. These claims look like enumerated paragraphs, each describing an aspect of the invention in one long sentence. Patent applications are given a serial number when they are filed at the U.S. Patent and Trademark Office. Patent applications are also published by the U.S. Patent and Trademark Office 18 months after they are filed (unless the applicant requests otherwise) and are given a separate patent application publication number.

Once the patent application issues as a patent (a process of usually 3-5 years), the entire patent application itself becomes the content of the official publication of the patent and is given a patent number. These publications are available (both in text and image format such as .pdf or .tiff) at the U.S. Patent and Trademark Office web site www.uspto.gov (in .tiff format), and at third party web sites like www.freepatentsonline.com and www.google.com/patents (in .pdf format) by typing in the patent number or patent application publication number. Also, during the pendency of a patent application there is a trail of written correspondence between the patent applicant and the U.S. Patent and Trademark Office (called the file history) which has a bearing on the interpretation of the patent claims. Thus, this “file history” is of particular importance to potential buyers of the patent and is usually in the form of a black and white .pdf document can typically be between 30 and 300 pages long. People interested in obtaining a file history of a patent must order and pay for it directly from the U.S. Patent and Trademark Office or from a 3rd party web site like www.micropatent.com or www.delphion.com.

Patents and patent applications are intellectual property assets that can be exchanged, sold and licensed much like any other piece of property. They can be licensed exclusively or non-exclusively. An exclusive license is an agreement between the patent owner and another individual to let only that particular individual (and perhaps the patent owner) use the invention. A non-exclusive license is an agreement between the patent owner and another individual to let that particular individual use the invention, but the patent owner is still allowed to license it to others too. The key pieces of information that a potential buyer or licensee would need to evaluate a patent or patent application for sale is the patent document or patent application document (if not yet issued as a patent), the file history of the patent or patent application (usually a lengthy .pdf document), any other legal history of the patent, the seller's terms, and the “family tree” of the patent. The family tree refers to other patents or patent applications that are directly related in a legal fashion to the patent or patent application in question. These related applications are often called continuation patent applications because there is at least one inventor in common between the original patent application and the continuation patent application.

Other countries have similar patent systems, but the published patent documents, file histories and family tree information are not as easy to obtain here in the U.S. over the internet as those for U.S. patents.

Currently, patent owners who want to sell their patents will typically go through a patent broker who will shop the patent around unsolicited to potential buyers. The patent broker will then charge a commission or other fee for the service. Sometimes, a patent broker will hold a patent auction with a number of select patents for sale. Alternatively, the patent owner can go unsolicited to potential buyers directly themselves and attempt to sell the patent. This process is often slow and cumbersome. The search for a potential buyer is riddled with dead ends and unsolicited letters or “cold calls” made to potential buyers who have no interest in the patent and who often ignore these unsolicited offers for other reasons of avoiding legal liability.

Likewise, a potential buyer who is interested in acquiring intellectual property assets in a certain area of technology may have to advertise generally that they are interested in acquiring such assets in order to get potential sellers to approach them. This may be undesirable for many buyers who do not want to advertise they are searching for patents to buy or license, thus resulting in them hiring a patent broker to advertise for them. As an alternative or in addition to advertising that they are interested in acquiring patent assets, the potential buyer can search (or hire someone to search) an official Patent Office web site or other web site that lists all the millions of issued patents. However, many of these patents are either not for sale, expired or do not have the current owner contact information readily available. The burden is on the buyer to find the owner and determine if the owner would be willing to sell or license it (thus alerting the patent owner that the potential buyer may be a future target for a patent infringement suit). Also, all the information that the buyer needs to properly evaluate and perform due diligence for a potential IP acquisition must be collected by the buyer or broker individually, often from a variety of different sources and web sites. This process also results in delays and unneeded expense, which does not provide an efficient market for the exchange of patent rights.

Four web sites that currently have systems that attempt to provide an avenue online for sellers to list and buyers to search patents for sale are www.tynax.com, www.freepatentauction.com and www.newideatrade.com. While all these web sites have their advantages, they also all have their drawbacks including lack of options, features, functionality, interfaces and ease of use that buyers, sellers, and patent brokers would expect in order to quickly evaluate patents listed for sale or license.

In this regard, there is a need for systems and methods that overcome the shortcomings described above and others.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In consideration of the above-identified shortcomings of the art, systems and methods for listing, buying and selling patents and patent applications online are described herein. For several embodiments, a system for listing patent or patent application intellectual property assets for sale or license may comprise means for receiving an intellectual property asset document number through an online interface, means for automatically extracting textual data regarding an intellectual property asset using the number received as input to a remote online system that serves over a network the textual data regarding the intellectual property asset, means for automatically storing the extracted data in a listing of the intellectual property asset, means for automatically advertising the intellectual property asset for sale or license using the stored data and means for automatically providing the listing in a searchable database of listings advertising intellectual property assets for sale or license such that the textual data regarding the intellectual property asset is searchable to users of the database, wherein the intellectual property asset is a patent or patent application.

Other features and embodiments are described below.

### BRIEF DESCRIPTION OF THE DRAWINGS

Systems and methods for listing, buying and selling patents and patent applications online are further described with reference to the accompanying drawings in which:

FIG. 1 is a block diagram representing an exemplary computing environment suitable for use in conjunction with implementing systems methods for listing, buying and selling patents and patent applications online;

FIG. 2 illustrates an exemplary networked computing environment in which many computerized processes may be implemented to per form listing, buying and selling patents and patent applications online;

FIG. 3 is a block diagram of a first part of a web site architecture of an example web site for listing, buying and selling patents and patent applications online;

FIG. 4 is a block diagram of a second part of a web site architecture of an example web site for listing, buying and selling patents and patent applications online;

FIG. 5 a flow chart illustrating an example process for seller registration on an example web site for listing, buying and selling patents and patent applications online and for listing/removing patents for sale on the web site;

FIG. 6 is a flow chart illustrating a first part an example internal process for automatically extracting and storing patent data once a seller fills out and submits an intellectual property asset listing form;

FIG. 7 is a flow chart illustrating a second part of an example internal process for automatically extracting and storing patent data once a seller fills out and submits an intellectual property asset listing form;

FIG. 8 is a flowchart illustrating processes and actions that occur when a user clicks on various corresponding items on a search results page of the example web site for listing, buying and selling patents and patent applications online;

FIG. 9 is a flowchart illustrating additional processes and actions that occur when a user clicks on various additional corresponding items on a search results page of the example web site for listing, buying and selling patents and patent applications online;

FIG. 10 is a diagram illustrating an example of an intellectual property asset listing interface form that a seller fills out to list their patents or patent applications for sale or license online;

FIG. 11 is diagram illustrating an example of how the intellectual property asset listing interface form of FIG. 9 appears after the user clicks on the “Provide Further Information Regarding Portfolio as a Whole” button on the intellectual property asset listing interface form; and

FIG. 12 is diagram illustrating an example search results page that appears when a user enters a search for patents on the web site for listing, buying and selling patents and patent applications online.

### DETAILED DESCRIPTION

Certain specific details are set forth in the following description and figures to provide a thorough understanding of various embodiments. Certain well-known details often associated with computing and software technology are not set forth in the following disclosure to avoid unnecessarily obscuring the various embodiments. Further, those of ordinary skill in the relevant art will understand that they can practice other embodiments without one or more of the details described below. Finally, while various methods are described with reference to steps and sequences in the following disclosure, the description as such is for providing a clear implementation of various embodiments, and the steps and sequences of steps should not be taken as required to practice the embodiments.

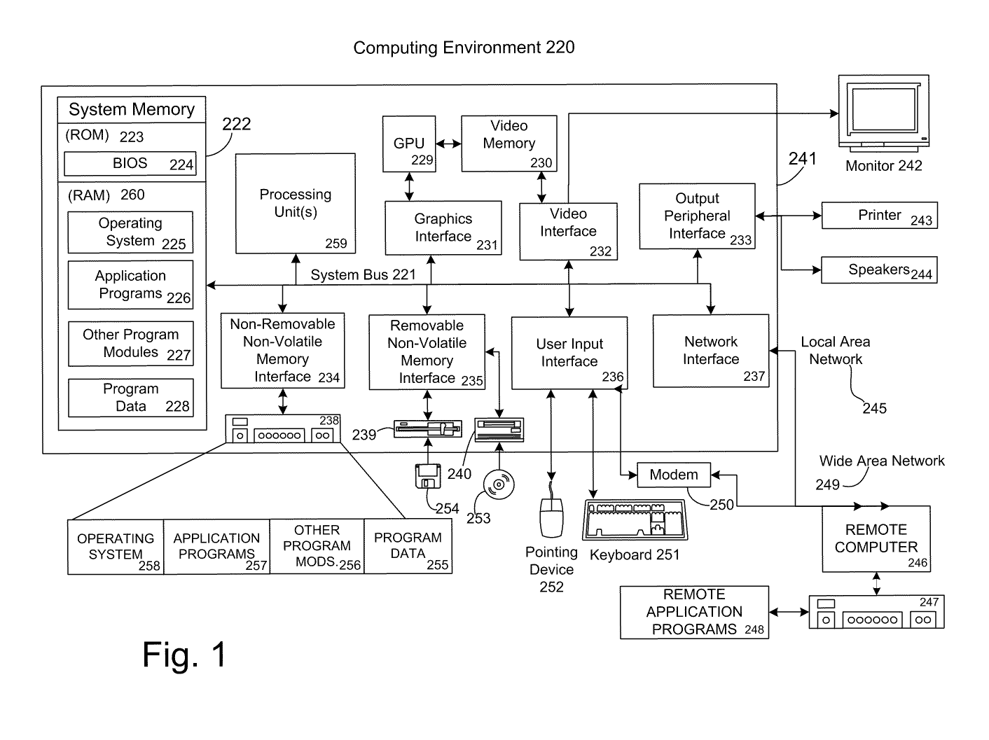

Referring next to FIG. 1, shown is a block diagram representing an exemplary computing environment suitable for use in conjunction with implementing the processes described below. For example, the computer-executable instructions that carry out the processes and methods for listing, buying and selling patents and patent applications online may reside and/or be executed in such a computing environment as shown in FIG. 1. The computing environment 220 is only one example of a suitable computing environment and is not intended to suggest any limitation as to the scope of use or functionality of the embodiments. Neither should the computing environment 220 be interpreted as having any dependency or requirement relating to any one or combination of components illustrated in the exemplary computing environment 220. For example a mobile device may also include one or more items such as those described below for use in conjunction with implementing the processes described below.

Aspects of the embodiments are operational with numerous other general purpose or special purpose computing environments or configurations. Examples of well known computing systems, environments, and/or configurations that may be suitable for use with the embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the embodiments may be implemented in the general context of computer-executable instructions, such as program modules, being executed by a computer. Generally, program modules include routines, programs, objects, components, data structures, etc. that perform particular tasks or implement particular abstract data types. Aspects of the embodiments may also be practiced in distributed computing environments where tasks are per formed by remote processing devices that are linked through a communications network. In a distributed computing environment, program modules may be located in both local and remote computer storage media including memory storage devices.

An exemplary system for implementing aspects of the embodiments includes a general purpose computing device in the form of a computer 241. Components of computer 241 may include, but are not limited to, a processing unit 259, a system memory 222, a graphics interface 231, a graphics processing unit (GPU) 229, video memory 230, video interface 232 and a system bus 221 that couples various system components including the system memory 222 to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and include both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, random access memory (RAM), read-only memory (ROM), Electrically Erasable Programmable Read-Only Memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Combinations of any of the above should also be included within the scope of computer readable media.

The system memory 222 includes computer storage media in the form of volatile and/or nonvolatile memory such as ROM 223 and RAM 260. A basic input/output system (BIOS) 224, containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 1 provide storage of computer readable instructions, data structures, program modules and other data for the computer 241. In FIG. 1, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus 221, but may be connected by other interface and bus structures, such as a parallel port, game port or a universal serial bus (USB). A monitor 242 or other type of display device is also connected to the system bus 221 via an interface, such as a video interface 232. In addition to the monitor 242, computer 241 may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 1. The logical connections depicted in FIG. 1 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device 247. By way of example, and not limitation, FIG. 1 illustrates remote application programs 248 as residing on the remote memory storage device 247. It will be appreciated that the network connections shown are exemplary and other means of establishing a communications link between the computers may be used.

It should be understood that the various techniques described herein may be implemented in connection with hardware or software or, where appropriate, with a combination of both. As used herein a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform the intended function of the system or subsystem. Thus, the methods and apparatus of the embodiments, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the embodiments, e.g., through the use of an application programming interface (API), reusable controls, or the like. Such programs are preferably implemented in a high level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the embodiments in the context of one or more stand-alone computer systems, the embodiments are not so limited, but rather may be implemented in connection with any computing environment, such as a network or distributed computing environment. Still further, aspects of the embodiments may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

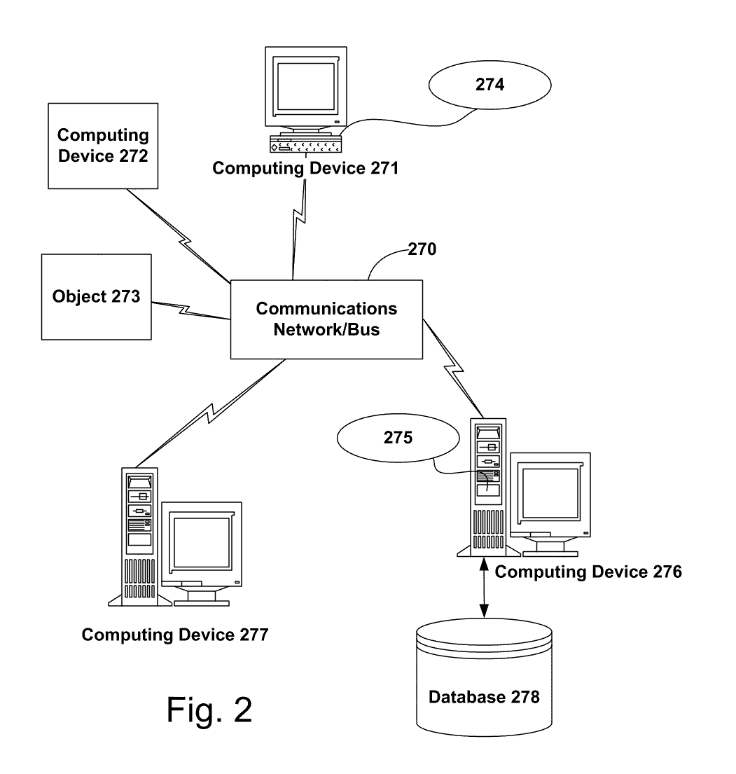

Referring next to FIG. 2, shown is an exemplary networked computing environment in which many computerized processes may be implemented to perform the processes described below. For example, parallel computing may be part of such a networked environment with various clients on the network of FIG. 2 using and/or implementing listing, buying and selling patents and patent applications online. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2, and may itself represent multiple interconnected networks. In accordance with aspects of the embodiments, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 2 and the further diversification that can occur in computing in a network environment such as that of FIG. 2, the systems and methods provided herein cannot be construed as limited in any way to a particular computing architecture. Instead, the embodiments should be construed in breadth and scope in accordance with the appended claims.

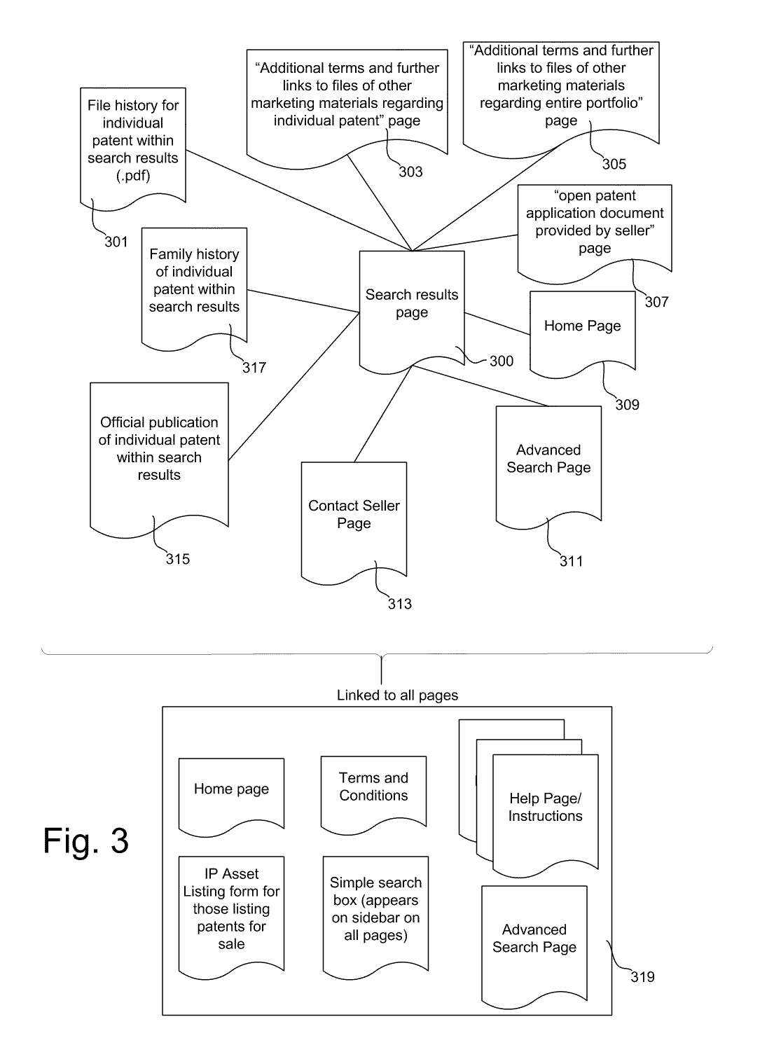

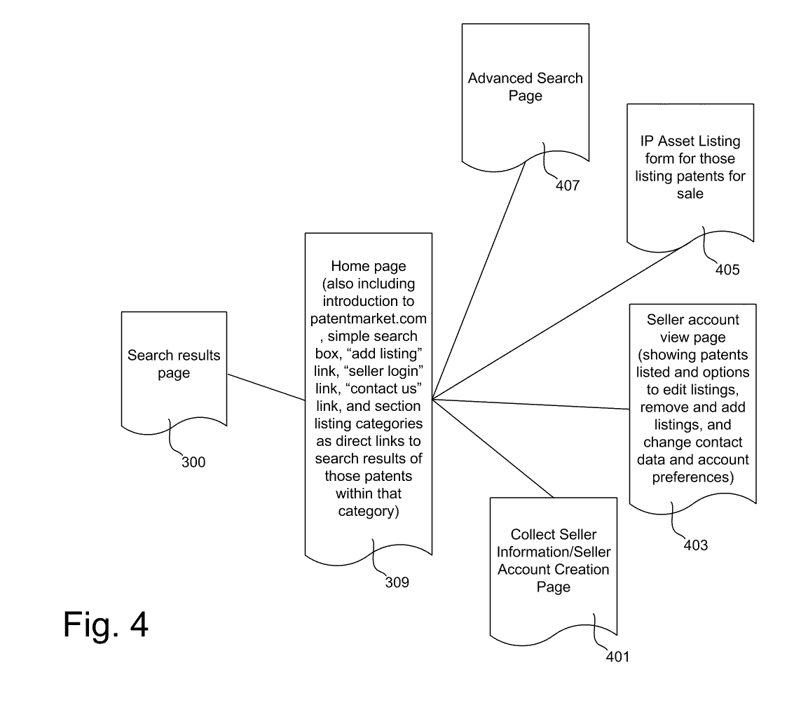

Referring next to FIGS. 3 and 4 shown are a block diagrams of a first part and second part of a web site architecture of an example web site for listing, buying and selling patents and patent applications online. The web site may have a URL such as www.patentmarket.com, for example, and the example web site will be referred to herein as patentmarket.com. There may be a home page 309 with a clean and professional look that will have links to other pages as shown in FIG. 3 and FIG. 4. The home page 309 may be linked to a “search results” page 300, “Collect Seller Information/Seller Account Creation” page 401, “Seller account view” page 403 (showing patents listed and options to edit listings, remove and add listings, and change contact data and account preferences), “IP asset listing form” page 405 for those listing patents for sale, and an “Advanced Search” page 407.

The search results page 300 may have links to other pages such as “file history” page 301, “Additional terms and further links to files of other marketing materials regarding individual patent” page 303, “Additional terms and further links to files of other marketing materials regarding entire portfolio” page 305, “Open patent application document provided by seller” page 307, home page 309, “Advanced Search” page 311, “Contact Seller” page 313, “Official publication of individual patent within search results” page 315, and “Family history of individual patent within search results” page 317. There may be links on all or most pages of the patentmarket.com web site to the “Help Page/instructions” page, “Terms and Conditions” page, “Simple search box,” “Advanced Search” page and “IP Asset listing form” pages 319. The help links on each page will be linked to appropriate information and instructions for that particular help link. For example, there may be separate links on the home page to instructions on how to sell and buy patents using the web site. There should be a simple search box on the home page as the focal point for the page wherein users can enter search terms to search the patents and patent applications for sale/license. There may also be a sidebar on all pages (except those appearing as pop-ups) including this simple search box.

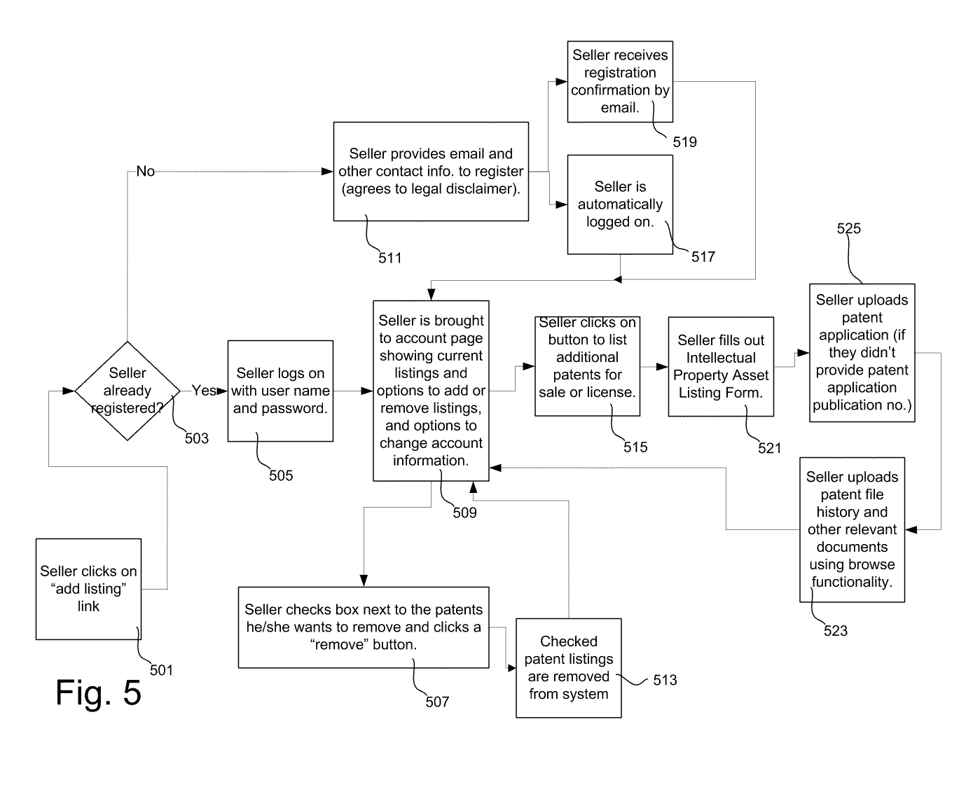

Referring next to FIG. 5, shown is a flow chart illustrating an example process for seller registration on the example patentmarket.com web site for listing, buying and selling patents and patent applications online and for listing/removing patents for sale on the web site.

In one embodiment the seller will be required to create an account to list their patents or patent applications, but they will then be able to log back on to manage and their account and add or remove their listings. Also, if they have the patent number or patent application publication number, they do not need to upload the patent or patent application. Based on the patent document number provided by the seller, patentmarket.com will automatically go to an external web site such as the U.S. Patent and Trademark Office web site www.uspto.gov/patft/index.html, www.freepatentsonline.com or www.google.com/patents, for example to automatically extract and store the text of the patent or patent application publication. This will most likely be the through U.S. Patent and Trademark Office web site. Patentmarket.com will also provide a link in the search results to the .pdf patent document published on an external web site such as www.freepatentsonline.com or www.google.com/patents.

The following information may be collected from a seller in order for a seller to create an account to list patents or patent applications for sale/license on patentmarket.com:

Seller Contact Information Collection Page (example):

| | | | Make | |
|---|---|---|---|---|
| | | | available to | |
| | | | potential | |
| | | | buyers? | |
| | | | Yes | No |
| First Name (required) | (text box for seller to | | | |
| | fill in information) | | | |
| Last Name (required) | (text box for seller to | | | |
| | fill in information) | | | |
| Company (optional) | (text box for seller to | | | |
| | fill in information) | | | |
| Address (required) | (text box for seller to | | | |
| | fill in information) | | | |
| Street | (text box for seller to | | | |
| | fill in information) | | | |
| City | (text box for seller to | | | |
| | fill in information) | | | |
| State/Province | (text box for seller to | | | |
| | fill in information) | | | |
| Country | (text box for seller to | | | |
| | fill in information) | | | |
| zip/postal code | (text box for seller to | | | |
| | fill in information) | | | |
| Email address (required) | (text box for seller to | | | |
| | fill in information) | | | |
| Phone number (optional) | (text box for seller to | | | |
| | fill in information) | | | |
| I want to be contacted through | Yes | No | | |
| patentmarket.com only (keep all | | | | |
| my contact information hidden) | | | | |
| Allow potential buyers to | Yes | No | | |
| contact me anonymously through | | | | |
| patentmarket.com (allow buyers | | | | |
| to keep their contact | | | | |
| information hidden) | | | | |

Patentmarket.com will provide both the buyer and seller an option such that they may contact and reply to the other anonymously through an email form that patentmarket.com will provide. Also, the seller can choose which information to keep hidden from potential buyers when the buyer clicks on a “contact seller” link.

Patentmarket.com may provide both the buyer and seller an option such that they may contact and reply to the other anonymously through an email form that patentmarket.com will provide. Also, the seller can choose which information to keep hidden from potential buyers when the buyer clicks on a “contact seller” link.

When the seller clicks 501 on an “add listing” link on patentmarket.com, it will be determined 503 whether the seller is already registered. If the seller is already registered, the seller logs on 505 with their user name and password and then is brought 509 to the seller's account page showing current listings and options to add or remove listings, and options to change account information. If the seller is not already registered, then the seller provides 511 email and other contact information to register (and agrees to a legal disclaimer). The seller then receives 519 a registration confirmation by email containing a link to conform the email address and may be automatically logged on 517 once the link in the confirmation email is followed. The seller is then is brought 509 to the seller's account page showing current listings and options to add or remove listings, and options to change account information.

The seller may then click 515 on a button or link to list additional patents for sale or license. The seller is then brought to a page to list additional patents for sale or license and completes 521 an Intellectual Property Asset listing form online. If listing a patent application, the seller may then upload 525 a patent application to patentmarket.com (if they didn't provide patent application publication no.). The seller may then upload 523 a patent file history and other relevant documents using a browse functionality on the patentmarket.com web site. The seller may then click on a submit button or link to submit their listing. The seller is then brought back 509 or proceeds back to the account page.

To remove listings, the seller may check 507 a box next to the patents or patent application listings the seller wants to remove. The checked patent listings are then removed 513 from the web site.

In another embodiment, the seller is not required to create an account to list their patents or patent applications, but they will not then be able to log back on to manage and their account and add or remove their listings until they register as a user. In this “quick listing” option, the seller merely provides their contact information such as their email address and the patent number or patent application publication number. Again, they do not need to upload the patent or patent application or provide the text of the patent or patent application. Based on the patent document number provided by the seller, patentmarket.com will automatically go to an external web site such as the U.S. Patent and Trademark Office web site www.uspto.gov/patft/index.html, www.freepatentsonline.com or www.google.com/patents, for example to automatically extract and store the text of the patent or patent application publication on the patentmarket.com web site under the seller's listing for that asset. If the seller later desires to edit, remove or manage their listings they had submitted under the “quick listing” option, the seller would then register as a user on the patentmarket.com web site providing the same email address or other identifiable contact data during the registration process that they had provided when submitting the listings under the “quick listing” option. The patentmarket.com web site will then use the email address or other identifiable contact data to find the previous listings submitted by that user under the “quick listing” option and automatically include them in the user's registered account. In this way, the user will be able to edit, remove or manage their listings they had previously submitted under the “quick listing” option.

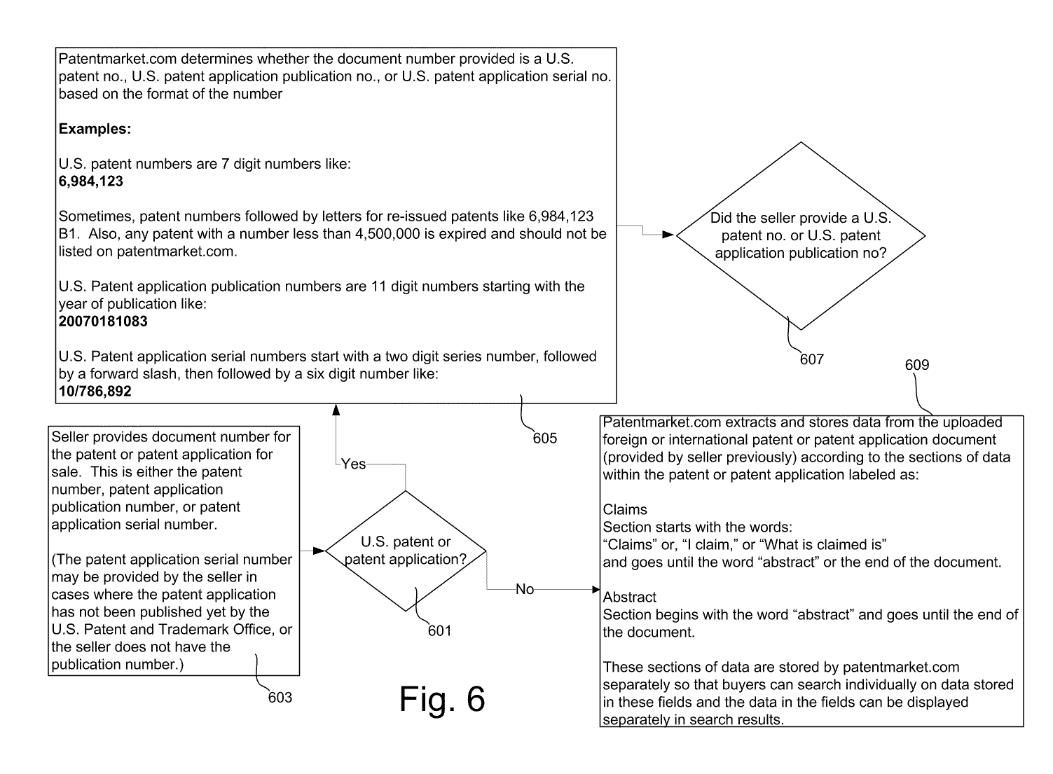

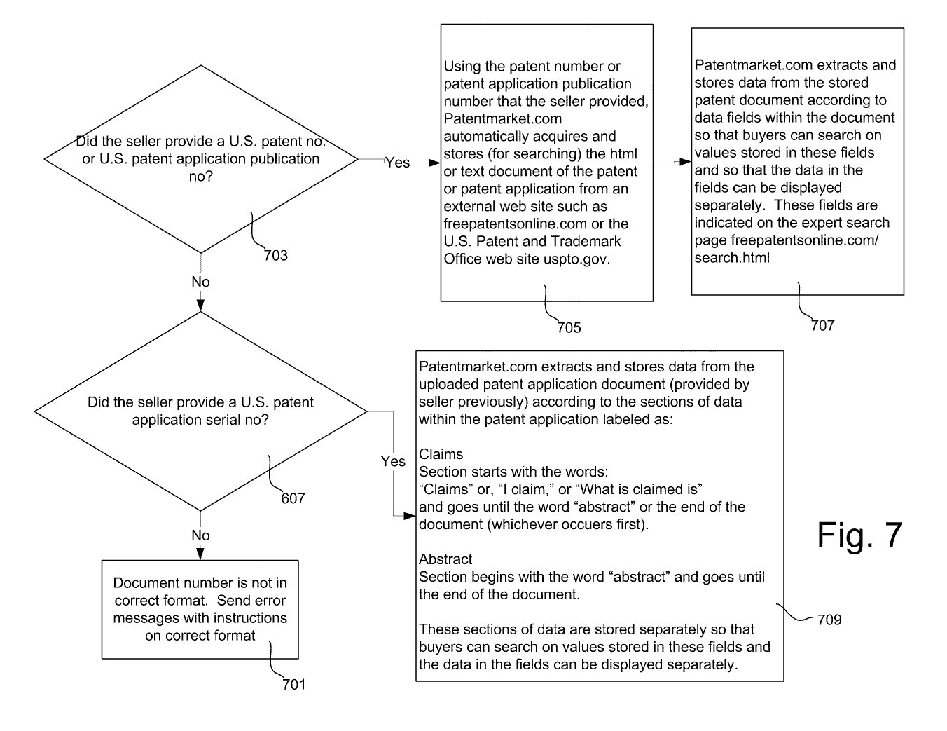

Referring next to FIGS. 6 and 7, shown are flow charts illustrating a first part and second part, respectively, of an example internal process for automatically extracting and storing patent data once a seller fills out and submits an intellectual property asset listing form.

Using the patent number or patent application publication number provided by the seller, patentmarket.com will automatically go to an external web site such as the U.S. Patent and Trademark Office web site www.uspto.gov/patft/index.html, www.freepatentsonline.com or www.google.com/patents to extract and store the text of the patent or patent application publication. This will most likely be through the U.S. Patent and Trademark Office web site. Patentmarket.com also provides a link to the .pdf patent document previously stored on patentmarket.com or to the document published on an external web site such as www.freepatentsonline.com or www.google.com/patents. However, if the patent has not been issued or the patent application has not been published yet by the U.S. Patent and Trademark Office, the seller may upload the patent application document themselves in a text or searchable format like Microsoft Word® or the like. The reason patentmarket.com stores the text or searchable version of the patent documents is that these will provide the data in which patentmarket.com will perform searches for potential buyers.

Based on the format of the number provided, patentmarket.com will detect whether it is a patent or patent application being listed. Also, particular data within particular fields within the text or searchable document will be automatically tagged or stored separately by patentmarket.com so that potential buyers can search on those individual fields. These fields are indicated on the expert search page www.freepatentsonline.com/search.html.

Specifically, a seller may provide 603 a document number for the patent or patent application for sale or license. This is either the patent number, patent application publication number, or patent application serial number. (The patent application serial number may be provided by the seller in cases where the patent application has not been published yet by the U.S. Patent and Trademark Office, or the seller does not have the publication number.) It is then determined 601 by the patentmarket.com web site whether the document number provided is that of a U.S. patent or patent application or not. This may be based on whether the user entered the number in section of an asset listing form on the patentmarket.com web site designated for U.S. patent or patent applications. For example, a section of an asset listing form on the patentmarket.com web site may designated for U.S. patent or patent applications and other section designated for foreign or international patents and patent applications.

If the seller did not provide a U.S. patent or patent application then patentmarket.com extracts and stores 609 data from the uploaded foreign or international patent or patent application document (provided by seller previously) according to the sections of data within the patent or patent application labeled as:

### Claims

Section starts with the words:
“Claims” or, “I claim,” or “What is claimed is”
and goes until the word “abstract” or the end of the document.

### Abstract

Section begins with the word “abstract” and goes until the end of the document.

These sections of data are stored by patentmarket.com separately so that buyers can search individually on data stored in these fields and the data in the fields can be displayed separately in search results.

If the seller did list a U.S. patent or patent application then patentmarket.com determines 605 whether the document number provided is a U.S. patent no., U.S. patent application publication no., or U.S. patent application serial no. based on the format of the number, for example.

U.S. patent numbers are 7 digit numbers like 6,984,123. Sometimes, patent numbers followed by letters for re-issued patents like 6,984,123 B1. Also, any patent with a number less than 4,500,000 is assumed expired and would not be listed on patentmarket.com. U.S. Patent application publication numbers are 11 digit numbers starting with the year of publication like: 20070181083. U.S. Patent application serial numbers start with a two digit series number, followed by a forward slash, then followed by a six digit number like 10/786,892.

For example, if the document number is a 7 digit number, then it may be determined that the number is a patent number. If the document number is an 11 digit number then it may be determined that the number is a patent application publication number. If the document number starts with a two digit series number, followed by a forward slash “/”, then it may be determined that the document number is a patent application serial number.

It is then determined 607 whether the seller provided a U.S. patent number or U.S. patent application publication number as described above, for example. Referring to FIG. 7, if the seller provided a U.S. patent number or U.S. patent application publication number, then using the patent number or patent application publication number that the seller provided as input, patentmarket.com automatically acquires and stores (for searching) 705 the html or text document of the patent or patent application from an external web site such as www.freepatentsonline.com or the U.S. Patent and Trademark Office web site www.uspto.gov. Patentmarket.com extracts and stores 707 data from the stored patent document according to data fields within the document so that buyers can search on values stored in these fields and so that the data in the fields can be displayed separately.

If the seller did not provide a U.S. patent number or U.S. patent application publication number, it is then determined 607 whether the seller provided a U.S. patent application serial number as described above, for example. If the seller provided a U.S. patent application serial number, then patentmarket.com extracts and stores 709 data from the uploaded patent application document (provided by the seller previously) according to the sections of data within the patent application labeled as:

### Claims

Section starts with the words:
“Claims” or, “I claim,” or “What is claimed is”
and goes until the word “abstract” or the end of the document (whichever occurs first).

### Abstract

Section begins with the word “abstract” and goes until the end of the document.

The above sections of data extracted from the uploaded patent application are stored separately so that buyers can search on values stored in these fields and the data in the fields can be displayed separately.

At this point, if it is then determined that the seller did not provide a U.S. patent application serial number (i.e., the format of the document number provided did not match any of those above for a U.S. patent no., U.S. patent application publication no., or U.S. patent application serial no.), then an error message is sent 701 with instructions on correct the format of the document number provided.

The following is an example functionality of a web page on patentmarket.com where a potential buyer will search for patents or patent applications for sale or license. There is a simpler search option on the front home page of the patentmarket.com web site (including just a box to enter search data and a “search patents for sale” label). Also, there may be a category search option where the user can click on a category and it brings up all the patents in that category. If particular search criteria are not indicated by the user, the default will be to search all patents and patent applications.

### Advanced Search Page

Search Criteria

| | text box for the user to |
|---|---|
| | enter search terms and |
| Search Terms | search expressions |
| Search Button | button |
| Search by patent number or patent | text box for user to |
| application number | fill in patent or patent |
| | application No. |
| Search patents only | check box |
| Search patent applications only | check box |
| Search both patents and patent applications | check box |
| Search those for sale only | check box |
| Search those offered for license only | check box |
| Search both those offered for license and | check box |
| those for sale | |
| Advanced search options | |

The advanced search functionality is able to search on the standard fields found in a U.S. patent document and the search options are also available at the Patent Trademark Office (USPTO) web site www.uspto.gov/patft/index.html. There may also be additional fields/points of data to search on such as those above. Patentmarket.com will obtain the searchable html patent document text automatically from an external web site or data service such as www.freepatentsonline.com or from the U.S. Patent Trademark Office (USPTO) web site www.uspto.gov/patft/index.html using the patent number or patent application publication number collected from the seller when they listed the patent. If the patent application has not been published yet by the patent office, or is a foreign patent or patent application, it may not be available on U.S. Patent and Trademark Office web site www.uspto.gov/patft/index.html or www.freepatentsonline.com and, but can be searched based on the title, claims and abstract of the patent application uploaded by the seller.

When the user clicks on the search button or hits enter, the web site will search all the patents or patent applications uploaded by the sellers according to the search criteria entered. For example, the search will be limited to those patents or patent applications falling within at least one of the patentmarket.com categories and/or by the U.S. Patent and Trademark Office classifications entered by the user. If a particular patent or patent application that comes up on a search is part of a larger portfolio listed for sale, all the patents and patent applications in that portfolio show up within the search results.

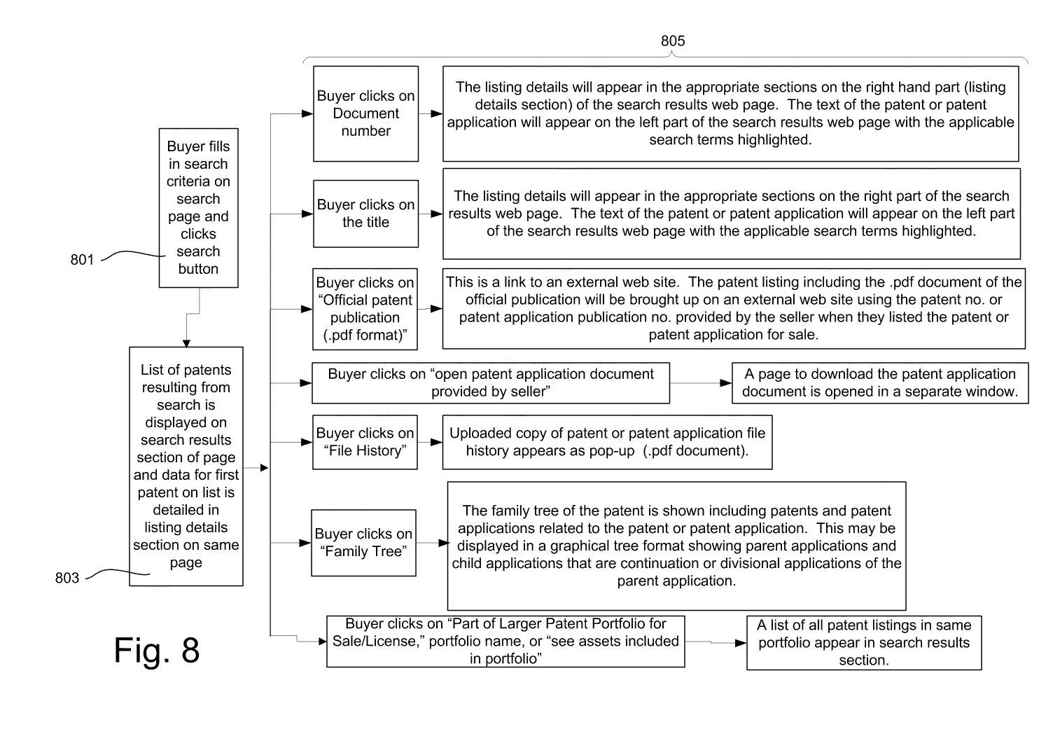

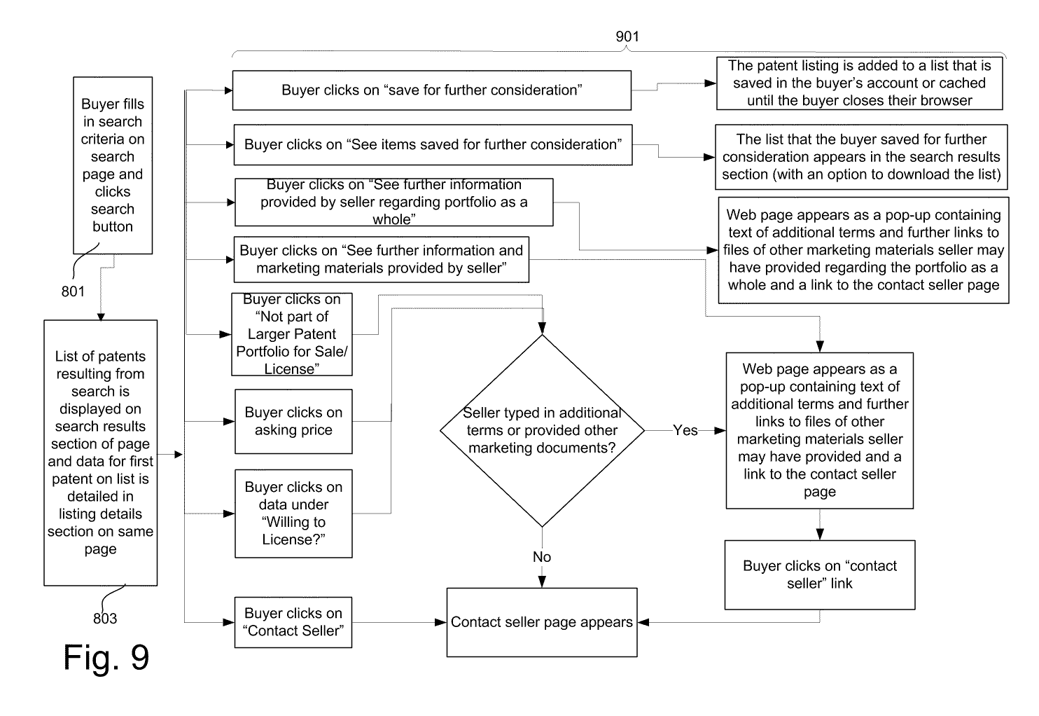

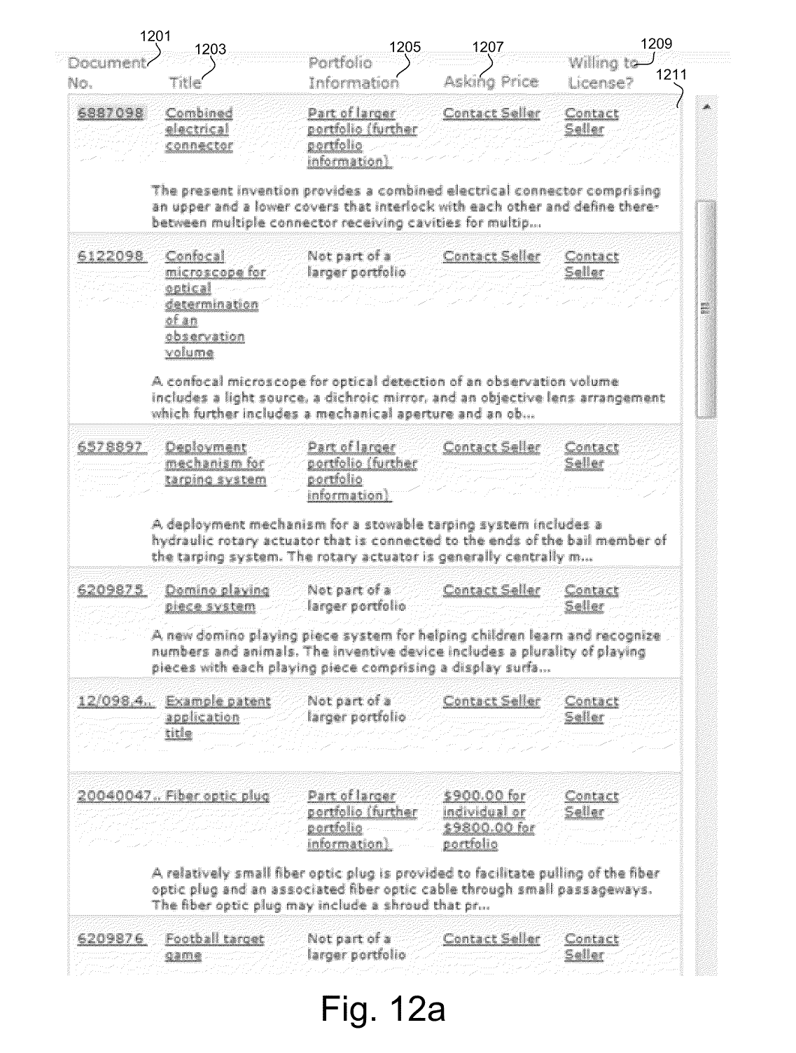

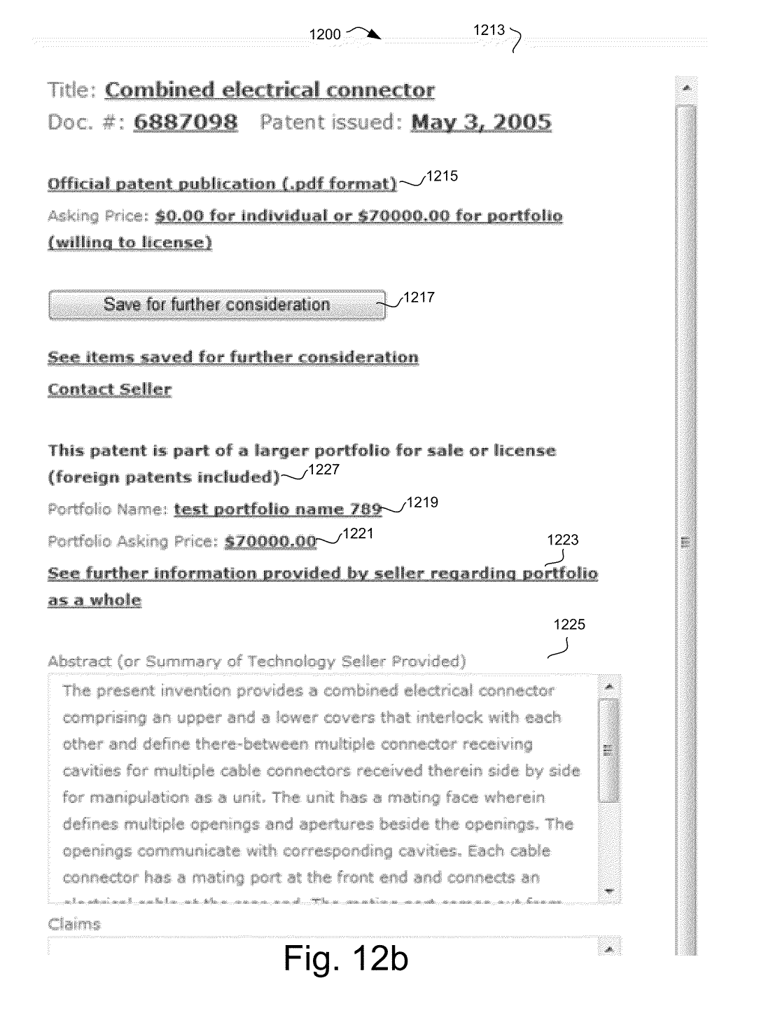

Referring next to FIGS. 8, 9, and 12, shown is a diagram (FIG. 12) illustrating an example search results page 1200 that appears when a user enters a search for patents on the patentmarket.com web site and flowcharts (FIGS. 8 and 9) illustrating example automatic processes and actions that occur when a user clicks on various corresponding items on the search results page 1200 of the example patentmarket.com web site.

If a potential buyer or licensee (hereinafter referred to as buyer) fills in search criteria on a search page and clicks 801 the search button, a list of asset listings resulting from the search is displayed 803 in a search results section 1211 of the search results page 1200 and data for the first patent on the list is automatically displayed in the detailed view section 1213 on the same page (see FIG. 12 as an example). The applicable automatic processes and actions 805 901 that occur when a user clicks on various corresponding items on a search results page such as that shown in FIG. 12, are shown in FIGS. 8 and 9.

The left side of the page displays the search results 1211 as a scrollable list under the headings document number 1201, title 1203, Portfolio Information 1205, Asking Price 1207 and Willing to License? 1209. The search results on the left hand side of the search results page 1200 are separately scrollable up and down with the search results headings (document number 1201, title 1203, etc.) remaining in place (i.e., frozen). The right hand side of the search results page 1200 is the detailed view 1213 that appears when the user clicks on a particular listing in the search results 1211. This right side is dynamic in that it will change to display the details of a particular listing when the user clicks on the listing or (or any links within that listing) within the search results 1211 on the left hand side of the page. Also, the search terms entered by the user are highlighted within the search results and detailed listing. Also, the document number of the current listing shown in the detailed view 1213 is also highlighted in the search results 1211. Both the search results listing 1211 on the left hand side of the page and the detailed view 1213 on the right hand side of the page are fully viewable without the user having to scroll left or right when they have their web browser window fully open.

The information in the search results under the column headings “Portfolio Information” 1205, “Asking Price” 1207 and “Willing to License?” 1209 will be according to the information provided by the seller on the Intellectual Property Asset Listing Form 1000 when they submitted the listing. Note that the detailed view 1213 includes information for a particular listing. This information may include, but is not limited to: a link to the official patent publication 1215 (in .pdf format, for example), individual scrollable sections of the patent or patent application 1225 (such as the abstract, claims, and entire patent application, for example), whether the asset listing is part of a larger portfolio for sale or license 1227, the applicable portfolio name 1219, portfolio asking price 1221, and link to further information provided by the seller regarding the portfolio as a whole 1223. Also included may be a link or button 1217 to save the listing for further consideration.

The appropriate links in the detailed view 1213 on the right hand side of the search results page 1200 will appear according to the information regarding the particular listing that the user clicks on in the search results 1211. For example, the links to further information 1223 on the right hand side of the page 1200 in the detailed view 1213 will not appear if no further information was provided by the seller for that listing. Also, if the listing is not part of a larger portfolio for sale, no indication will appear on the detailed listing on the right hand side of the page that the listing is part of a larger portfolio for sale.

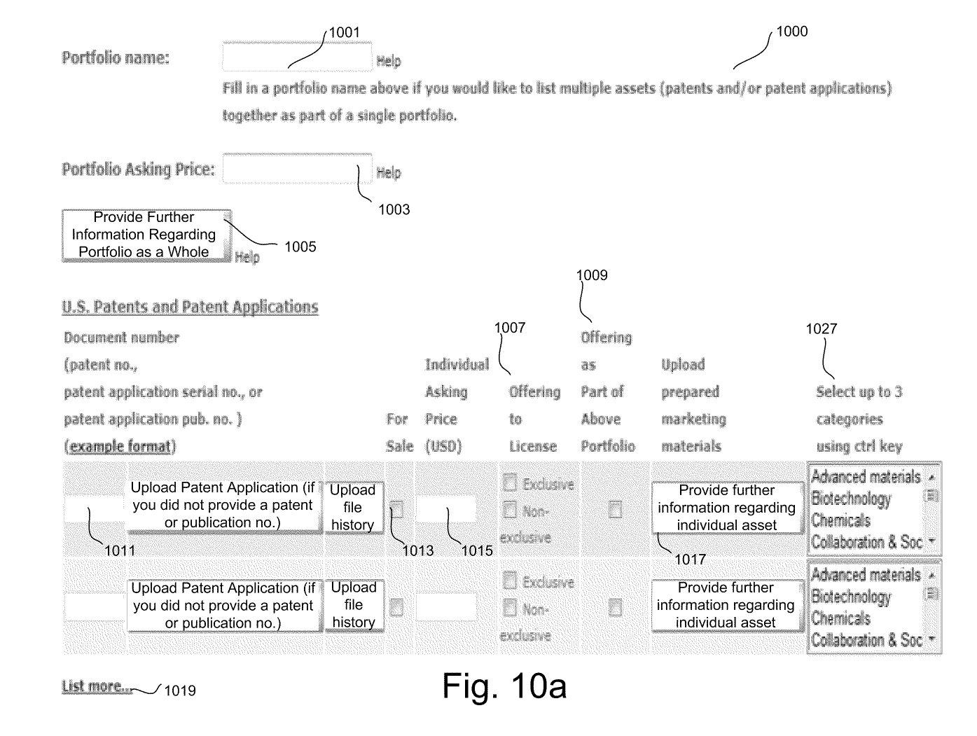

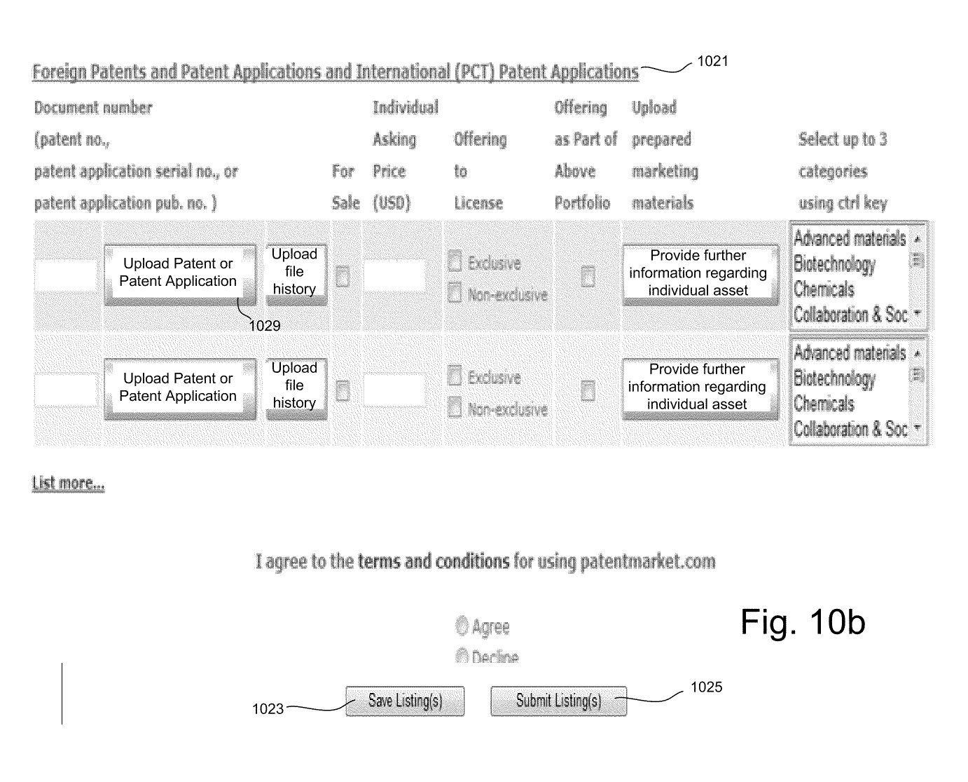

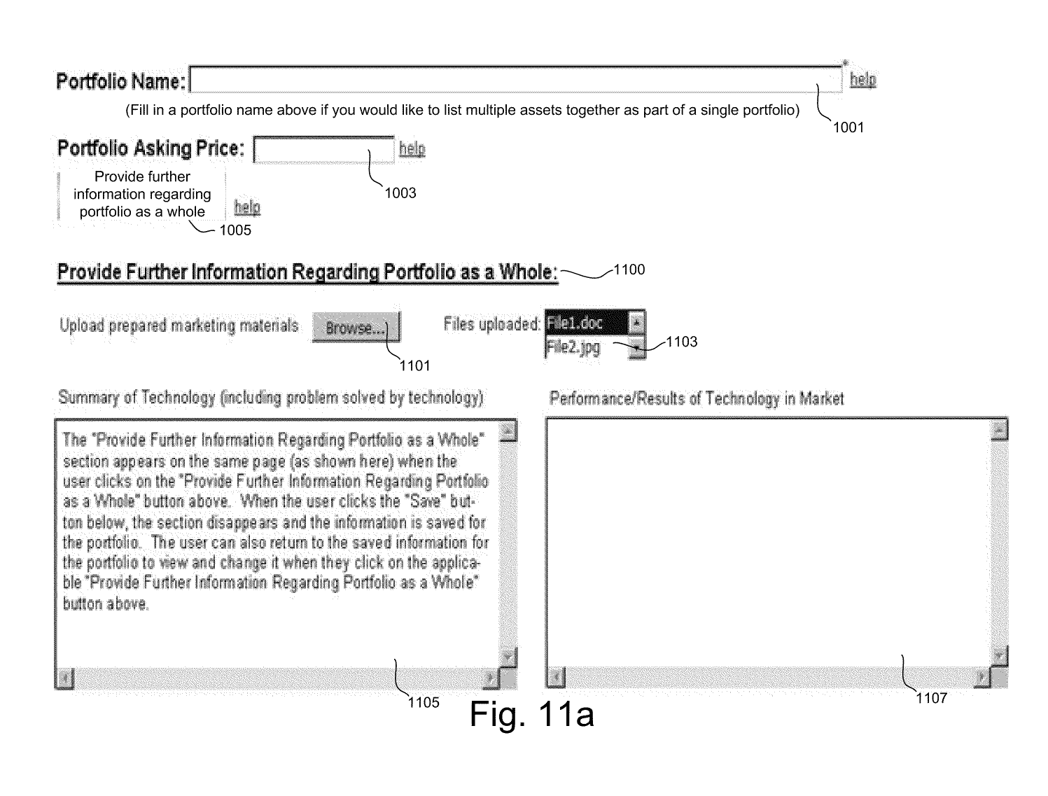

Referring next to FIG. 10, shown is a diagram illustrating an example of an intellectual property asset listing interface form 1000 that a seller fills out to list their patents or patent applications for sale or license online on patentmarket.com. The asset listing form 1000 can be used to list multiple assets at one time (either separately, together as one portfolio, or both). Also, there are options 1005 1017 for the seller or licensor to provide additional information and documents individually for each asset and/or for the portfolio as a whole.

The seller fills out the online asset listing form 1000 for the patents and patent applications the seller would like to list for sale or license. The seller may check all boxes that apply. For example, if the seller would consider both either selling or licensing their patent, the seller can check both the “For Sale,” 1013 and “Offering to license” 1007 boxes.

All the entries on the asset listing form are optional except, for example, the document number 1011, uploading the patent application (if the seller did not provide a patent application publication number), and providing portfolio name (if the seller is offering multiple intellectual property (IP) assets as one portfolio). Patentmarket.com will automatically collect the patent or published patent application and other information based on the document number provided.

The seller may indicate which listings are to be included together as part of a larger portfolio of listings by entering a portfolio name 1001 and checking the applicable “offering as part of the above portfolio” box 1009 next to the applicable listing being added. The seller may also provide a portfolio asking price 1003 to indicate an asking for the entire portfolio of assets.

The seller can click on the “Provide further information” 1005 1017 buttons to provide a summary of the technology, more detail on the deal structure sought, upload their own marketing materials, and provide other additional information. The seller may provide further information regarding the portfolio as a whole by clicking the “Provide further information regarding portfolio as a whole” button 1005 and may provide further information regarding individual listings by clicking the “Provide further information regarding individual asset” button 1017. This additional information will be available to potential buyers under each listing or portfolio when potential buyers search for listings on the patentmarket.com web site.

By default, the asset listing form 1000 shows two rows for listing two separate assets at one time using the same asset listing form. However, the user may list more assets at the same time using the same asset listing form by clicking on “list more” link 1019, at which point additional rows will appear for listing additional assets using the same asset listing form. There are also a “submit listing(s)” button 1025 and a “save listing(s)” button 1023 at the bottom of the asset listing form 1000 to save and submit the listings accordingly.

As mentioned above, based on the patent document number provided by the seller, patentmarket.com will automatically go to an external web site such as the U.S. Patent and Trademark Office web site www.uspto.gov/patft/index.html, www.freepatentsonline.com or www.google.com/patents, for example to extract and store the text of the patent or patent application publication once the submit listing button 1025 is clicked. This will most likely be from the U.S. Patent and Trademark Office web site. However, if the patent has not been issued or the patent application has not been published yet by the U.S. Patent and Trademark Office, the seller may upload the patent application document themselves in a text or searchable format like MS Word or the like.

There is also a section 1021 on the asset listing form 1000 to list foreign patents and patent applications and PCT (international) patent applications. These have their own section because there are a number of different types of numbering schemes and formats for foreign patents and patent applications which make it difficult to automatically retrieve the data from external web sites. Thus, for foreign patents and patent applications, the seller may upload the patent or patent application document themselves. When the user clicks on the “Upload patent or patent application” button 1029, a pop-up web page will appear with an option to upload both a searchable (e.g., text version) of the foreign patent or patent application and a copy of the official published document (e.g., in .pdf format).

As shown in FIG. 10, there is a category list 1027 menu for each individual asset listing. This may be a fairly large set of categories and the seller will be able to select up to three of them for each asset being listed, for example. However, in other embodiments, a larger number of categories may be selected. Thus, the drop-down menu is designed so that most (if not all) the categories are visible using a scroll bar and so that up to three are easily selectable by the seller when they click on the drop down menu. Note that this set of categories available on the drop-down menu may be different from those classifications used by the U.S. Patent and Trademark Office to categorize individual patents and patent applications or may be the same. However, when a potential buyer is searching for patents or patent applications, the search functionality on patentmarket.com allows the user to search on U.S. Patent and Trademark Office classifications given to the patent by the U.S. Patent and Trademark Office as well as the patentmarket.com categories that were chosen by the seller in the menu 1027 for the asset listing.

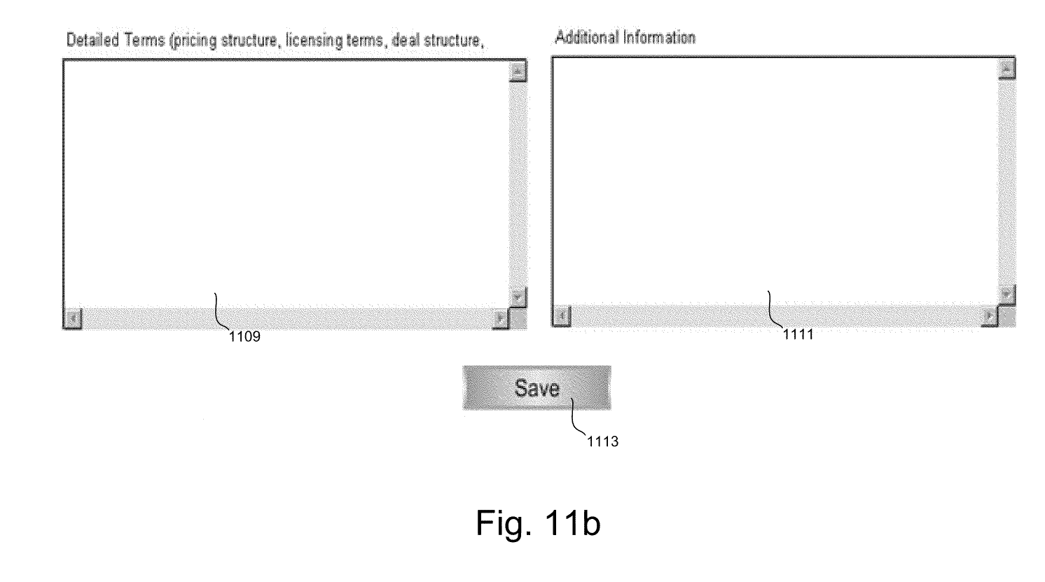

Referring next to FIG. 11, shown is a diagram illustrating an example of how the intellectual property asset listing interface form 1000 of FIG. 9 appears after the user clicks on the “Provide Further Information Regarding Portfolio as a Whole” button 1005 on the intellectual property asset listing interface form. When the user clicks on either the “Provide Further Information Regarding Portfolio as a Whole” button 1005 or the Provide Further Information Regarding Individual Asset” button 1017 (shown in FIG. 10), the intellectual property asset listing form 1000 will expand to provide the corresponding section 1100 (as shown in FIG. 11, for example, for providing further information regarding the portfolio as a whole) the for the seller to fill in and upload the further information.

There is a button 1101 for the user to browse on their computer to locate and choose files containing prepared marketing materials for uploading to patentmarket.com. There may be a limit on the total size of the uploaded attachments 1103 and saved text for each listing of about 12 MB, for example. There are sections 1105 1107 1109 1111 for the user to enter or cut and paste a summary of the technology 1105, more detail on the deal structure sought 1109, and provide other additional information 1111. Also, there is an option 1113 for the user to save the further information provided which will in effect save all the information on the form entered in that section so far in the seller's account (perhaps under a patentmarket.com listing number) and close that applicable section of the form. If the seller clicks on one of the “Provide Further Information” 1005 1017 buttons again, the corresponding section will re-appear with the saved information for a particular individual asset or the entire portfolio as a whole (depending on what button they clicked on), allowing the user to add or change the information. This will also allow the seller to close out of their browser or log out and come back to complete or change their listing(s) at a later time before submitting them. The option to save the information provided so far on the form may also be available at the bottom of the form as the “Save Listing(s)” button 1023 (shown in FIG. 10). Note that when the seller logs back in to view or edit their listing(s) there may be an indication next to each listing whether it has been submitted or just saved.

Patentmarket.com web site has security typical of web sites that store personal information and user accounts. There is standard virus protection to prevent viruses uploaded inadvertently or maliciously through the document upload option for potential sellers. Also, there is protection form denial of service, hacking and other attacks, including those through potential automated access of patentmarket.com through web bots and the like. This includes, but is not limited to generating a random series of characters and presenting them as an image for the user to type in when a user registers and when they submits their listings.

There may also be a technological feature on the patentmarket.com web site which allows users to buy a share of a patent rather than an entire patent wherein each share of the patent consists of ownership or other rights associated with the patent or group of patents or IP assets (i.e., a portfolio of assets) that would entitle the owner of the share of the patent or group of IP assets to a portion of the licensing revenues, royalties, right to exclude others from using the invention(s), or proceeds from a future sell of the patents or group of IP assets. The system would then allow these shareholders to sell their shares to other interested parties on the web site marketplace or other marketplaces. The owner of a patent or group of IP assets may offer on patentmarket.com their patent or group of IP assets for sale or license to an individual or put it up for sale as shares to those interested. This would be like an initial public offering of a patent. Patentmarket.com would then become an online location for those to buy and sell shares of patents or groups of IP assets as well as entire patents and groups of IP assets.

It is noted that the foregoing examples have been provided merely for the purposes of explanation and are in no way to be construed as limiting of the present invention. While the invention has been described with reference to various embodiments, it is understood that the words which have been used herein are words of description and illustration, rather than words of limitations. Further, although embodiments have been described herein with reference to particular means and materials, the invention is not intended to be limited to the particulars disclosed herein; rather, the invention extends to all functionally equivalent structures, methods and uses, such as are within the scope of the appended claims. Those skilled in the art, having the benefit of the teachings of this specification, may provide numerous modifications thereto and changes may be made without departing from the scope and spirit of the invention in its aspects.

What is claimed:

1. A method for listing patent or patent application intellectual property assets for sale or license wherein one or more computer processors cause performance of steps comprising:
receiving an intellectual property asset document number through an online interface;
automatically extracting textual data regarding an intellectual property asset using the number received as input to a remote online system that serves over a network the textual data regarding the intellectual property asset;
automatically storing the extracted data in a listing of the intellectual property asset;
automatically advertising the intellectual property asset for sale or license using the stored data; and
automatically providing the listing in a searchable database of listings advertising intellectual property assets for sale or license such that the textual data regarding the intellectual property asset is searchable to users of the database, wherein the intellectual property asset is a patent or patent application.

2. The method of claim 1 further comprising:
receiving submissions of multiple intellectual property asset listings through an online interface in order to advertise the intellectual property asset listings for sale or license;
receiving an indication through the online interface that selected intellectual property asset listings of the multiple intellectual property asset listings are to be grouped together as a single portfolio for sale or license;
automatically grouping the selected intellectual property asset listings of the multiple intellectual property asset listings together in a single portfolio based on the received indication; and
automatically advertising in a searchable online database the selected intellectual property asset listings for sale or license as part of a single portfolio based on the automatic grouping.

3. The method of claim 1 wherein the automatically extracting textual data regarding an intellectual property asset comprises:
automatically determining whether a type of the intellectual property asset is a patent or patent application by a format of the intellectual property asset document number received; and
automatically extracting textual data regarding the intellectual property asset using the determination of the type of the intellectual property asset to automatically input the received document number into either a patent search input interface or a patent application search input interface depending on whether the type of the intellectual property asset is a patent or patent application, the patent search input and patent application search input being of an online system that serves the textual data regarding the intellectual property asset over a network.

4. A method for listing patent or patent application intellectual property assets for sale or license wherein one or more computer processors cause performance of steps comprising:
receiving submissions of multiple patent or patent application intellectual property asset listings through an online interface in order to advertise the intellectual property asset listings for sale or license;
receiving an indication through the online interface that selected intellectual property asset listings of the multiple intellectual property asset listings are to be grouped together as a single portfolio for sale or license;
automatically grouping the selected intellectual property asset listings of the multiple intellectual property asset listings together in a single portfolio based on the received indication; and
automatically advertising in a searchable online database the selected intellectual property asset listings for sale or license as part of a single portfolio based on the automatic grouping.

5. The method of claim 4 further comprising:
receiving an indication through the online interface that selected intellectual property asset listings are also to be listed separately for sale or license; and
automatically advertising in a searchable online database the selected intellectual property asset listings for sale or license separately and also as part of the single portfolio based on the automatic grouping and received indication through the online interface that the selected intellectual property asset listings are also to be listed separately.

6. The method of claim 4 further comprising:
receiving an intellectual property asset document number through the online interface;
automatically extracting textual data regarding an intellectual property asset using the number received as input to an online system that serves the textual data regarding the intellectual property asset over a network;
automatically storing the extracted data in a listing of the intellectual property asset;
automatically advertising the intellectual property asset for sale or license using the stored data in the searchable online database.

7. A method for listing patent or patent application intellectual property assets for sale or license wherein one or more computer processors cause performance of steps comprising:
receiving a submission of a listing of a patent or patent application intellectual property asset through an online interface in order to advertise shares of the intellectual property asset for individual sale; and
automatically advertising in a searchable online database the shares of the intellectual property asset for individual sale based on the submission of the listing.

8. The method of claim 7 further comprising:
providing an option through an online interface to list the intellectual property asset for sale as a single asset or for sale as individual shares of the intellectual property asset; and
automatically advertising in the searchable online database the intellectual property asset for sale as a single asset or for sale as individual shares of the intellectual property asset according to an indication received through the online interface in response to the provided option.

9. The method of claim 7 further comprising:
receiving a submission of a listing of an intellectual property asset portfolio through an online interface in order to advertise shares of the intellectual property asset portfolio for individual sale; and
automatically advertising in a searchable online database the shares of intellectual property asset portfolio for individual sale based on the submission of the listing.

10. The method of claim 7 further comprising reducing a number of shares of the intellectual property asset available for individual purchase advertised on the searchable online database based on shares of the intellectual property asset previously purchased.

11. A system for listing patent or patent application intellectual property assets for sale or license comprising:
means for receiving an intellectual property asset document number through an online interface;
means for automatically extracting textual data regarding an intellectual property asset using the number received as input to an online system that serves the textual data regarding the intellectual property asset over a network;
means for automatically storing the extracted data in a listing of the intellectual property asset;
means for automatically advertising the intellectual property asset for sale or license using the stored data; and
means for automatically providing the listing in a searchable database of listings advertising intellectual property assets for sale or license such that the textual data regarding the intellectual property asset is searchable to users of the database, wherein the intellectual property asset is a patent or patent application.

12. The system of claim 11 further comprising:
means for receiving submissions of multiple intellectual property asset listings through an online interface in order to advertise the intellectual property asset listings for sale or license;
means for receiving an indication through the online interface that selected intellectual property asset listings of the multiple intellectual property asset listings are to be grouped together as a single portfolio for sale or license;
means for automatically grouping the selected intellectual property asset listings of the multiple intellectual property asset listings together in a single portfolio based on the received indication; and
automatically advertising in a searchable online database the selected intellectual property asset listings for sale or license as part of a single portfolio based on the automatic grouping.

13. The system of claim 11 wherein the means for automatically extracting textual data regarding an intellectual property asset comprises:
means for automatically determining whether a type of the intellectual property asset is a patent or patent application by a format of the intellectual property asset document number received; and
means for automatically extracting textual data regarding the intellectual property asset using the determination of the type of the intellectual property asset to automatically input the received document number into either a patent search input interface or a patent application search input interface depending on whether the type of the intellectual property asset is a patent or patent application, the patent search input and patent application search input being of an online system that serves the textual data regarding the intellectual property asset over a network.

14. A system for listing patent or patent application intellectual property assets for sale or license comprising:
means for receiving submissions of multiple patent or patent application intellectual property asset listings through an online interface in order to advertise the intellectual property asset listings for sale or license;
means for receiving an indication through the online interface that selected intellectual property asset listings of the multiple intellectual property asset listings are to be grouped together as a single portfolio for sale or license;
means for automatically grouping the selected intellectual property asset listings of the multiple intellectual property asset listings together in a single portfolio based on the received indication; and
means for automatically advertising in a searchable online database the selected intellectual property asset listings for sale or license as part of a single portfolio based on the automatic grouping.

15. The system of claim 14 further comprising:
means for receiving an indication through the online interface that selected intellectual property asset listings are also to be listed separately for sale or license; and
means for automatically advertising in a searchable online database the selected intellectual property asset listings for sale or license separately and also as part of the single portfolio based on the automatic grouping and received indication through the online interface that the selected intellectual property asset listings are also to be listed separately.

16. The system of claim 14 further comprising:
means for receiving an intellectual property asset document number through the online interface;
means for automatically extracting textual data regarding an intellectual property asset using the number received as input to an online system that serves the textual data regarding the intellectual property asset over a network;
means for automatically storing the extracted data in a listing of the intellectual property asset; and
means for automatically advertising the intellectual property asset for sale or license using the stored data in the searchable online database.

17. A system for listing patent or patent application intellectual property assets for sale or license comprising:
means for receiving a submission of a listing of a patent or patent application intellectual property asset through an online interface in order to advertise shares of the intellectual property asset for individual sale; and
means for automatically advertising in a searchable online database the shares of the intellectual property asset for individual sale based on the submission of the listing.

18. The system of claim 17 further comprising:
means for providing an option through an online interface to list the intellectual property asset for sale as a single asset or for sale as individual shares of the intellectual property asset; and
automatically advertising in the searchable online database the intellectual property asset for sale as a single asset or for sale as individual shares of the intellectual property asset according to an indication received through the online interface in response to the provided option.

19. The system of claim 17 further comprising:
means for receiving a submission of a listing of an intellectual property asset portfolio through an online interface in order to advertise shares of the intellectual property asset portfolio for individual sale; and
means for automatically advertising in a searchable online database the shares of intellectual property asset portfolio for individual sale based on the submission of the listing.

20. The system of claim 17 further comprising means for reducing a number of shares of the intellectual property asset available for individual purchase advertised on the searchable online database based on shares of the intellectual property asset previously purchased.

21. A computer readable medium for listing patent or patent application intellectual property assets for sale or license having computer executable instructions thereon for:
receiving an intellectual property asset document number through an online interface;
automatically extracting textual data regarding an intellectual property asset using the number received as input to an online system that serves the textual data regarding the intellectual property asset over a network;
automatically storing the extracted data in a listing of the intellectual property asset;
automatically advertising the intellectual property asset for sale or license using the stored data; and
automatically providing the listing in a searchable database of listings advertising intellectual property assets for sale or license such that the textual data regarding the intellectual property asset is searchable to users of the database, wherein the intellectual property asset is a patent or patent application.

22. The computer readable medium of claim 1 further comprising computer executable instructions thereon for:
receiving submissions of multiple intellectual property asset listings through an online interface in order to advertise the intellectual property asset listings for sale or license;
receiving an indication through the online interface that selected intellectual property asset listings of the multiple intellectual property asset listings are to be grouped together as a single portfolio for sale or license;
automatically grouping the selected intellectual property asset listings of the multiple intellectual property asset listings together in a single portfolio based on the received indication; and
automatically advertising in a searchable online database the selected intellectual property asset listings for sale or license as part of a single portfolio based on the automatic grouping.

23. The computer readable medium of claim 1 wherein the computer executable instructions thereon for automatically extracting textual data regarding an intellectual property asset comprise computer executable instructions thereon for:
automatically determining whether a type of the intellectual property asset is a patent or patent application by a format of the intellectual property asset document number received; and
automatically extracting textual data regarding the intellectual property asset using the determination of the type of the intellectual property asset to automatically input the received document number into either a patent search input interface or a patent application search input interface depending on whether the type of the intellectual property asset is a patent or patent application, the patent search input and patent application search input being of an online system that serves the textual data regarding the intellectual property asset over a network.

24. A computer readable medium for listing patent or patent application intellectual property assets for sale or license having computer executable instructions thereon for:
receiving submissions of multiple patent or patent application intellectual property asset listings through an online interface in order to advertise the intellectual property asset listings for sale or license;
receiving an indication through the online interface that selected intellectual property asset listings of the multiple intellectual property asset listings are to be grouped together as a single portfolio for sale or license;
automatically grouping the selected intellectual property asset listings of the multiple intellectual property asset listings together in a single portfolio based on the received indication; and
automatically advertising in a searchable online database the selected intellectual property asset listings for sale or license as part of a single portfolio based on the automatic grouping.

25. The computer readable medium of claim 4 further comprising computer executable instructions thereon for:
receiving an indication through the online interface that selected intellectual property asset listings are also to be listed separately for sale or license; and
automatically advertising in a searchable online database the selected intellectual property asset listings for sale or license separately and also as part of the single portfolio based on the automatic grouping and received indication through the online interface that the selected intellectual property asset listings are also to be listed separately.

26. The computer readable medium of claim 4 further comprising computer executable instructions thereon for:
receiving an intellectual property asset document number through the online interface;
automatically extracting textual data regarding an intellectual property asset using the number received as input to an online system that serves the textual data regarding the intellectual property asset over a network;
automatically storing the extracted data in a listing of the intellectual property asset;
automatically advertising the intellectual property asset for sale or license using the stored data in the searchable online database.

27. A computer readable medium for listing patent or patent application intellectual property assets for sale or license having computer executable instructions thereon for:
receiving a submission of a listing of a patent or patent application intellectual property asset through an online interface in order to advertise shares of the intellectual property asset for individual sale; and
automatically advertising in a searchable online database the shares of the intellectual property asset for individual sale based on the submission of the listing.

28. The computer readable medium of claim 7 further comprising computer executable instructions thereon for:
providing an option through an online interface to list the intellectual property asset for sale as a single asset or for sale as individual shares of the intellectual property asset; and
automatically advertising in the searchable online database the intellectual property asset for sale as a single asset or for sale as individual shares of the intellectual property asset according to an indication received through the online interface in response to the provided option.

29. The computer readable medium of claim 7 further comprising computer executable instructions thereon for:
receiving a submission of a listing of an intellectual property asset portfolio through an online interface in order to advertise shares of the intellectual property asset portfolio for individual sale; and
automatically advertising in a searchable online database the shares of intellectual property asset portfolio for individual sale based on the submission of the listing.

30. The computer readable medium of claim 7 further comprising computer executable instructions thereon for reducing a number of shares of the intellectual property asset available for individual purchase advertised on the searchable online database based on shares of the intellectual property asset previously purchased.
